(19) United States
(12) Patent Application Publication
(10) Pub. No.: US 2015/0101687 A1
(43) Pub. Date: Apr. 16, 2015

(54) Liquid Valve Design with internal Check Valve

(71) Applicant: Hamilton Sundstrand Corporation, Windsor Locks, CT (US)

(72) Inventors: Steve Shubat, Newington, CT (US); Donna S. Prause, Rocky Hill, CT (US)

(73) Assignee: Hamilton Sundstrand Corporation, Windsor Locks, CT (US)

(21) Appl. No.: 14/055,101

(22) Filed: Oct. 16, 2013

(51) Int. Cl. F16K 17/04

(52) U.S. Cl. CPC F16K 17/0406
USPC 137/513.7; 251/315.16

(57) ABSTRACT

A valve is provided including a valve body and a valve element arranged within the valve body. The valve body includes an inlet port, an outlet port, and an inner surface that defines a flow channel. The valve element includes a through passage and is configured to rotate between an open position and a closed position to control a flow of fluid through the flow channel. A check valve assembly is arranged within the valve element generally perpendicular to the through passage. The check valve assembly is configured to move between a first position and a second position in response to an increase in pressure when the valve element is in a closed position.

### BACKGROUND OF THE INVENTION

Embodiments of the invention relate to valves, and more particularly, to a ball valve including a check valve for releasing pressure within a fluid circuit.

Conventional ball valves are used as a mechanism for regulating fluid flow. A typical ball valve includes a housing having an inlet port and an outlet port. A through bore internally connects the inlet port to the outlet port. A central chamber is positioned in the path of the through bore. A ball having a second through bore is positioned within the central chamber. The ball is configured to rotate within the central chamber. In a first, or open, position the through bore of the ball is aligned with the through bore of the valve such that fluid flows between the inlet and outlet ports. In a second, or closed, position, the through bore of the ball is perpendicular to the through bore of the valve such that the fluid is not allowed to flow from the inlet port to the outlet port. The ball can be rotated between the first and second positions to control flow through the valve.

In a fluid circuit including a valve, such as a ball valve for example, a relief or expansion chamber is commonly included to handle expansion of the fluid while the valve is partially or fully open. Once the valve is closed, however, only the portion of the circuit before or after the valve will be protected from over pressurization depending on the location of the relief chamber relative to the valve. The increased pressure may cause damage or deformation, and may therefore shorten the lifespan of the components in the fluid circuit.

### BRIEF DESCRIPTION OF THE INVENTION

According to one embodiment of the invention, a valve is provided including a valve body and a valve element arranged within the valve body. The valve body includes an inlet port, an outlet port, and an inner surface that defines a flow channel. The valve element includes a through passage and is configured to rotate between an open position and a closed position to control a flow of fluid through the flow channel. A check valve assembly is arranged within the valve element generally perpendicular to the through passage. The check valve assembly is configured to move between a first position and a second position in response to an increase in pressure at the inlet port when the valve element is in a closed position.

According to another embodiment of the invention, a fluid circuit is provided including a first conduit and a second conduit operably connected by a valve. The valve includes a valve body and a valve element arranged within the valve body. The valve body includes an inlet port, an outlet port, and an inner surface that defines a flow channel. The first conduit is connected to the inlet port and the second conduit it connected to the outlet port. The valve element includes a through passage and is configured to rotate between an open position and a closed position to control a flow of fluid through the flow channel. A check valve assembly is arranged within the valve element generally perpendicular to the through passage. The check valve assembly is configured to move between a first position and a second position in response to an increase in pressure at the inlet port when the valve element is in a closed position.

### BRIEF DESCRIPTION OF THE DRAWINGS

The subject matter, which is regarded as the invention, is particularly pointed out and distinctly claimed in the claims at the conclusion of the specification. The foregoing and other features, and advantages of the invention are apparent from the following detailed description taken in conjunction with the accompanying drawings in which:

FIG. 1 is a cross-sectional view of an example of a valve;

FIG. 2 is a cross-sectional view of a valve element in an open configuration according to an embodiment of the invention;

FIG. 3 is a cross-sectional view of a valve element in an closed configuration according to an embodiment of the invention;

FIG. 4 is a cross-sectional view of the valve element including a check valve assembly in a first position according to an embodiment of the invention;

FIG. 5 is a cross-sectional view of the valve element including a check valve assembly in a second position according to an embodiment of the invention; and

FIG. 6 is a fluid circuit including the valve according to an embodiment of the invention.

The detailed description explains embodiments of the invention, together with advantages and features, by way of example with reference to the drawings.

### DETAILED DESCRIPTION OF THE INVENTION

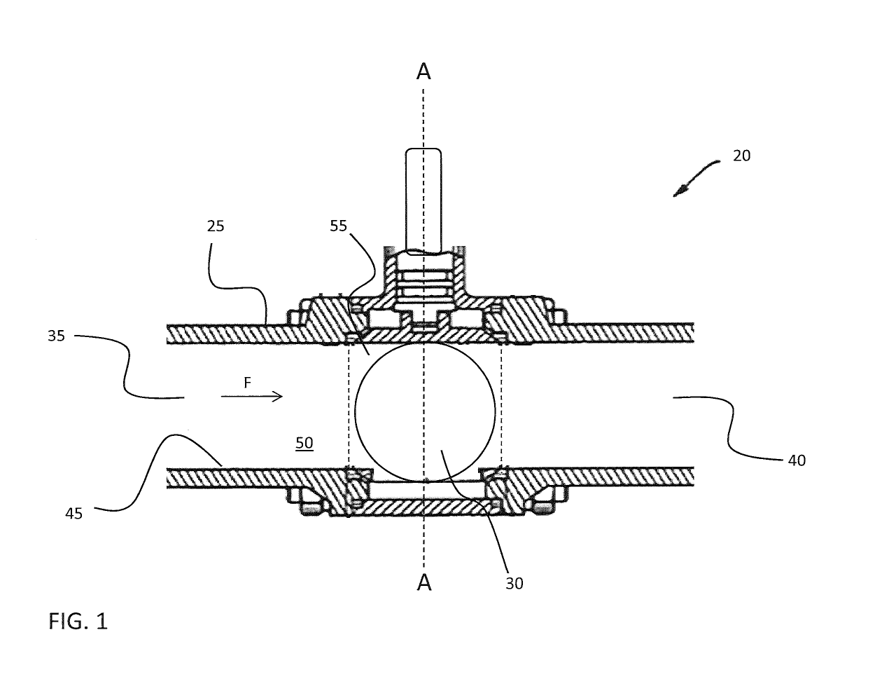

Referring now to FIG. 1, an exemplary valve 20 is illustrated. The valve 20 includes a tubular valve body 25 and a valve element 30. The valve body 25 includes an inlet port 35 and an outlet port 40, and an inner surface 45 that defines a flow channel 50. When the valve 20 is installed in a fluid system, such as a galley cooling unit of an aircraft (not shown) for example, fluid selectively flows in the direction indicated by arrow F, into the inlet port 35, through the flow channel 50, and out the outlet port 40. The capability for fluid to flow into and through the valve body 25 will depend, as will be appreciated, upon the position of the valve element 30 relative to the valve body 25.

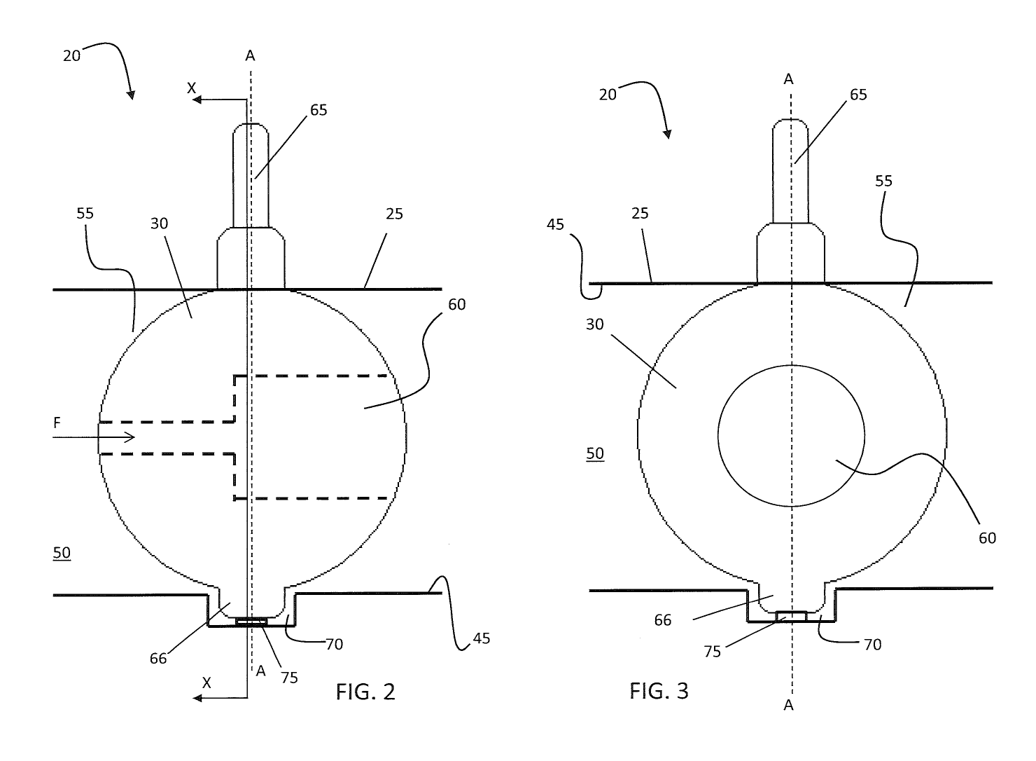

The valve element 30 is positioned within a chamber 55 of the valve body 25. The valve element 30 includes a through passage 60 (FIG. 2), for example having a large circular cross-section similar to the flow channel 50 of the valve body 25. In one embodiment, the valve element 30 is a ball. As shown in FIGS. 2 and 3, a shaft 65 extends axially from the valve element 30, in a direction generally perpendicular to the flow of fluid F, through the tubular valve body 25. The shaft 65 is rotationally mounted to the valve body 25, such as with at least one bearing (not shown) for example, such that the valve element 30 is configured to rotate about an axis A within the chamber 55 as the shaft 65 is rotated. In one embodiment, a portion 66 of the shaft 65 also extends beneath the valve element 30 into a generally cylindrical cavity 70 of the valve body 25.

Application of a rotational force to the shaft 65 causes the valve element 30 to rotate within the chamber 55 between a closed position and an open position. When the valve element 30 is in an open position (see FIG. 2), the through passage 60 of the valve element 30 is generally aligned with a fluid flow direction F in flow channel 50. In a closed position, illustrated in FIG. 3, the through passage 60 is generally perpendicular to the fluid flow direction F in the flow channel 50, and is therefore blocked by the inner surface 45 of the valve body 25. When the valve element 30 is in a closed position, fluid flow through the flow channel 50 is substantially prevented. The flow rate of fluid through the flow channel 50 may be controlled by rotating the valve element 30 partially between an open position and a closed position to adjust the orientation of the through passage 60 with respect to the flow channel 50. Arranged about the inner surface 45 of the valve body 25 is a seal 75. Regardless of whether the valve element 30 is in an open position, partially open position, or closed position, the seal 75 is configured to engage the valve element 30 about its circumference to prevent flow of a fluid between the inner surface 45 of the valve body 25 and the exterior of the valve element 30.

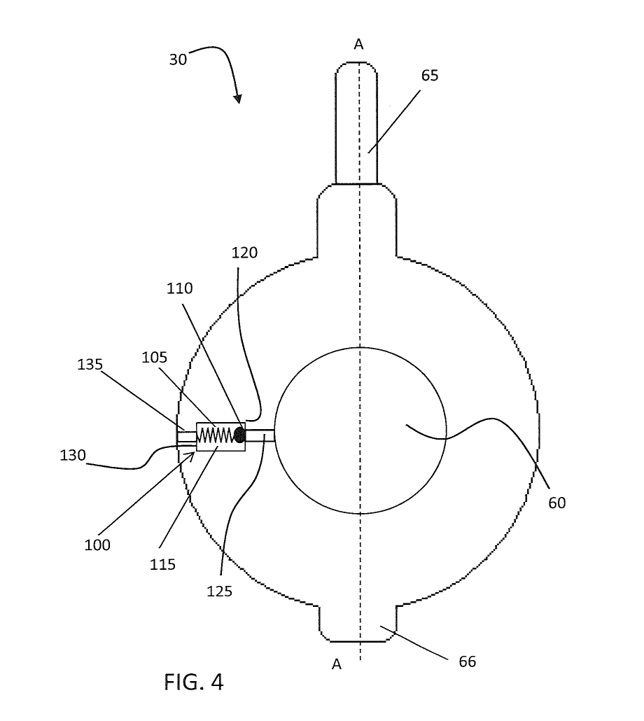

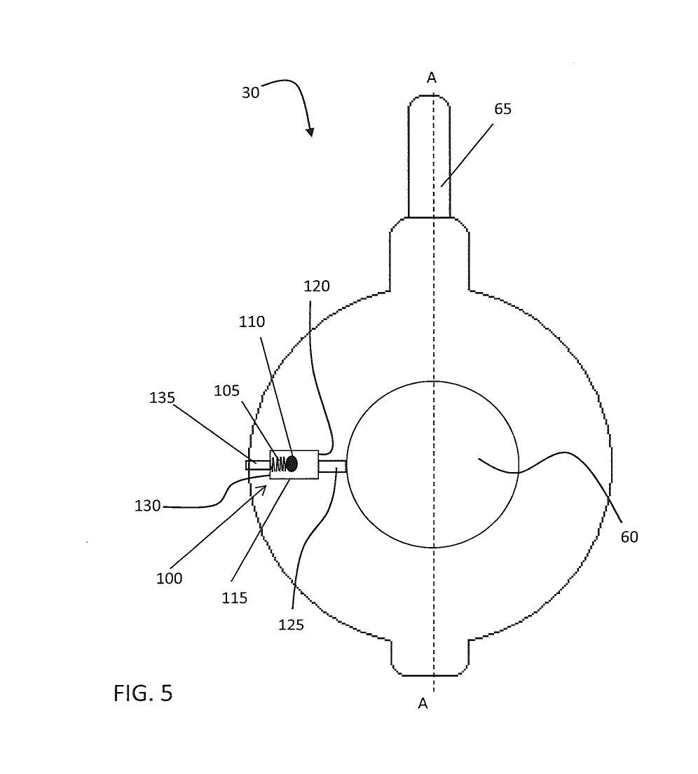

Referring now to FIGS. 4 and 5, a cross-section of the valve element 30 taken along line X-X (FIG. 2) is illustrated in more detail. A check valve assembly 100 arranged within the valve element 30 includes a biasing mechanism 105 and a sealing element 110, such as a ball for example, arranged within a hollow chamber 115. A first end 120 of the chamber 115 is connected to the through passage 60 of the valve element 30 by a first channel 125, and a second end 130 of the chamber 115 is connected to a second channel 135. In one embodiment, the check valve assembly 100 is arranged substantially perpendicular to the direction of flow through the through passage 60 of the valve element 30. Though illustrated near a center of the valve element 30, the check valve assembly 100 may be positioned anywhere within the valve element 30 along the through passage 60.

The sealing element 110 is movable between a first position (FIG. 4) and a second position (FIG. 5). The biasing member 105 is configured to bias the sealing element 110 into the first position adjacent the first end 120 of the chamber 115. In the first position, the sealing element 110 blocks or seals the interface between the chamber 115 and the first channel 125 to prevent a flow of fluid therein. In the second position, the biasing member 105 is at least partially compressed such that a space exists between the sealing element 110 and the first end 120 of the chamber 115, thereby allowing a flow of fluid through the chamber 115 and out the second channel 135.

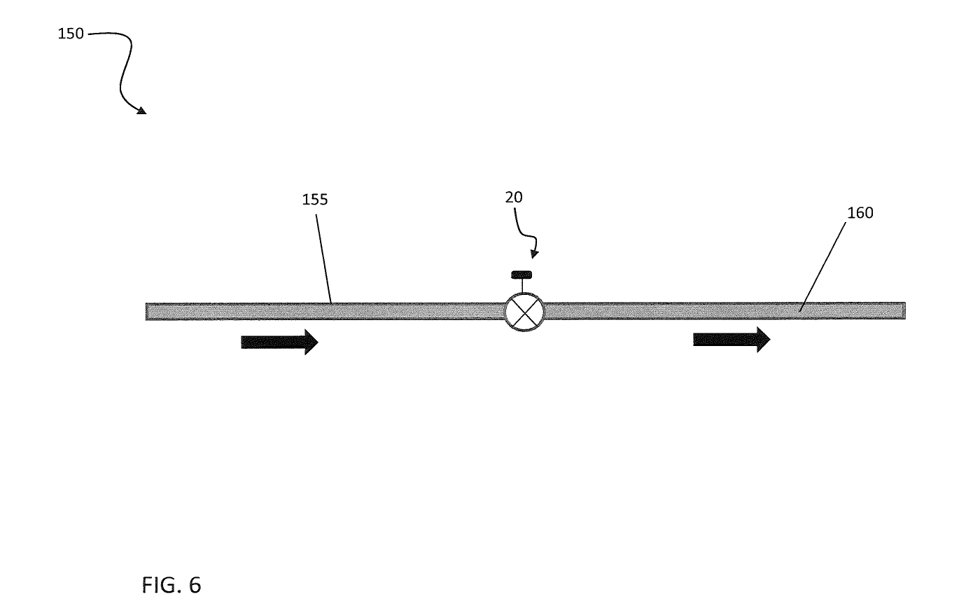

A fluid circuit 150 incorporating the valve 20 of FIGS. 1-5 is illustrated in FIG. 6. The circuit includes a first conduit 155 coupled to the inlet port 35 of the valve body 25 and a second conduit 160 coupled to the outlet port 40 of the valve body 25. Rotation of the valve element 30 (FIG. 1) controls the flow of fluid between the first conduit 155 and the second conduit 160. When the valve element 30 is in a generally open position, fluid flows freely from the first conduit 155, through the flow channel 50, to the second conduit 160. When the valve element 30 is in a closed position, fluid is blocked from flowing through the flow channel 50 to the second conduit 160. Because of the position of the seal 75, some fluid generally passes between the inner surface 45 of the valve body 25 and the valve element 30 into the through passage 60.

Pressure may continue to increase in the first conduit 155 over time due to increased temperature. If the pressure in the first conduit 155 exceeds the biasing force of the biasing mechanism 105, the pressure will cause the biasing mechanism 105 of the check valve assembly 100 to compress, thereby allowing the sealing element 110 to move away from the first end 120 of the chamber 115. After the sealing element 110 has moved away from the first end 120, fluid is free to flow through the first channel 125 into the chamber 115. In one embodiment, the diameter of the sealing member 110 is less than the diameter of the chamber 115, such that when the sealing member 110 is in a second position, fluid will flow around the sealing member 110 and into the second channel 135 (see FIG. 5). In the illustrated, non-limiting embodiment, the second channel 135 is operably coupled to the second conduit 160 such that the check valve assembly 100 provides a bypass through the valve element 30. Redistributing some of the fluid through the check valve assembly 100 to the second conduit 160 reduces the pressure in the first conduit 155. Once the pressure in the first conduit 155 is less than the biasing force of the biasing mechanism 105, the biasing mechanism 105 will bias the sealing element 110 back to the first position against the first end 120 of the chamber 115.

Inclusion of the check valve assembly 100 within the valve element 30 relieves the over pressurization of the fluid circuit 150 by balancing the pressure between the first and second conduits 155, 160 coupled to the valve 20. By reducing the over pressure in the circuit 150, damage to the system components will be reduced, and therefore the lifespan of the components will increase.

While the invention has been described in detail in connection with only a limited number of embodiments, it should be readily understood that the invention is not limited to such disclosed embodiments. Rather, the invention can be modified to incorporate any number of variations, alterations, substitutions or equivalent arrangements not heretofore described, but which are commensurate with the spirit and scope of the invention. Additionally, while various embodiments of the invention have been described, it is to be understood that aspects of the invention may include only some of the described embodiments. Accordingly, the invention is not to be seen as limited by the foregoing description, but is only limited by the scope of the appended claims.

1. A valve comprising:
a valve body including an inlet port and an outlet port and having an inner surface that defines a flow channel;
a valve element having a through passage, the valve element being arranged within the valve body and configured to rotate between an open position and a closed position to control a first flow of fluid through the flow channel; and
a check valve assembly arranged within the valve element generally perpendicular to the through passage, the check valve assembly being configured to move between a first position and a second position in response to an increase in pressure at the inlet port when the valve element is in a closed position.

2. The valve according to claim 1, wherein when the valve element is in an open position, the through passage is substantially parallel to the flow channel of the valve body and when the valve element is in a closed position, the through passage is substantially perpendicular to the flow channel of the valve body.

3. The valve according to claim 2, wherein the check valve assembly further comprises:
a hollow chamber, a first end of the hollow chamber being connected to the through passage by a first channel, a second end of the hollow chamber being connected to a second channel; and
a coupled biasing mechanism and sealing element arranged within the hollow chamber, the sealing element being configured to move between a first position and a second position.

4. The valve according to claim 3, wherein in the first position, the sealing element is configured to block a second flow of fluid into the hollow chamber.

5. The valve according to claim 4, wherein in the first position, the sealing element is arranged adjacent the first end of the hollow chamber.

6. The valve according to claim 3, wherein in the second position, the sealing element is configured to allow a second flow of fluid into the hollow chamber.

7. The valve according to claim 1, wherein the valve element is a ball.

8. A fluid circuit comprising:
a first conduit and second conduit operably connected by a valve, the valve including:
a valve body having an inlet port, an outlet port, and an inner surface that defines a flow channel, wherein the first conduit is coupled to the inlet port and the second conduit is coupled to the outlet port;
a valve element having a through passage, the valve element being arranged within the valve body and configured to rotate between an open position and a closed position to control a first flow of fluid between the first and second conduit; and
a check valve assembly arranged within the valve element generally perpendicular to the through passage, the check valve assembly being configured to move between a first position and a second position in response to an increase in pressure at the inlet port when the valve element is in a closed position.

9. The fluid circuit according to claim 8, wherein when the valve element is in an open position, the through passage is substantially parallel to the flow channel of the valve body and when the valve element is in a closed position, the through passage is substantially perpendicular to the flow channel of the valve body.

10. The fluid circuit according to claim 9, wherein the check valve assembly further comprises:
a hollow chamber, a first end of the hollow chamber being connected to the through passage by a first channel, a second end of the hollow chamber being connected to the second conduit by a second channel; and
a coupled biasing mechanism and sealing element arranged within the hollow chamber, the sealing element being configured to move between a first position and a second position.

11. The fluid circuit according to claim 10, wherein when a pressure in the first conduit exceeds a biasing force of the biasing mechanism, the pressure causes the sealing element to move from the first position to the second position.

12. The fluid circuit according to claim 11, wherein in the first position, the sealing element is configured to block a second flow of fluid into the hollow chamber.

13. The fluid circuit according to claim 11, wherein in the second position, the sealing element is configured to allow a second flow of fluid through the hollow chamber to the second conduit.

14. The fluid circuit according to claim 8, wherein the check valve is configured to provide a bypass for the second flow of fluid through the valve element.

15. The fluid circuit according to claim 8, wherein the valve element is a ball.
